(19) United States
(12) Patent Application Publication
(10) Pub. No.: US 2006/0192679 A1
(43) Pub. Date: Aug. 31, 2006

(54) Plant low water alerting apparatus

(76) Inventors: B. Shawn Buckley, San Jose, CA (US); Mary M. Buckley, San Jose, CA (US); Andrew P. Gang, Shenzhen (CN)

Correspondence Address: William B. Ritchle, 1411 Northern Heights drive NE, Rochester, MN, 55906, US

(21) Appl. No.: 11/348,384

(22) Filed: Feb. 6, 2006

Related U.S. Application Data
(60) Provisional application No. 60/653,767, filed on Feb. 17, 2005.

(51) Int. Cl. G08B 21/00; E04H 4/00

(52) U.S. Cl. 340/618; 4/508

(57) ABSTRACT

A self-contained apparatus detects the absence of water in a cut plant container and signals an audible alert. The alert sounds periodically until an attendant refills the water. The apparatus is a slender rigid structure that can easily fit inside a narrow vase of cut flowers. The top portion that remains above the normal water level holds the battery and electronic circuitry. The bottom portion, which rests against the container bottom, holds the water sensor. Various means of electronically distinguishing water from air are disclosed: thermal, vibrations, viscosity, density, acoustic, electromagnetic (including capacitance, microwaves, optical and beta rays), electrical contact, electrochemical, floats and pressure. The sensor has cavities in its structure to protect the sensor from handling, water damage and contamination. Some cavities are flooded having an opening above and below the normal container water level; the water inside a flooded cavity matches the water level in the container. Other cavities are dry to protect sensors and circuitry from water damage. Circuitry to detect the absence of water includes bridge circuits for variable resistance and variable voltage sensors. In addition, both self-impedance and mutual impedance circuits are disclosed.

### FIELD OF THE INVENTION

This invention relates to liquid level sensing apparatus, in particular, an alarm to indicate when the water level for cut flowers, Christmas trees and the like is below a pre-set level.

### BACKGROUND

Cut plants such as cut flowers are commonly kept in containers filled with water to keep them alive after being cut. The cut end of the plants is placed beneath the surface of the water inside the container to allow the cut ends to draw in water to keep the plants alive. As the plants use water, the level in the container drops.

Unless water is added to the container periodically, the water level can drop below the cut ends. Without water on the cut ends, they dry by natural processes. The plants themselves seal the dried cut ends. Once a cut end is sealed, further water is prevented from being drawn into the plant, even if the container is filled again with water. The purpose of this invention is to produce an audible signal whenever the water inside the container drops below a preset level in the container.

Cut plants represent a large market. Over a billion bunches of cut flowers are sold yearly. Yet many of these cut plants dry out prematurely because the water in their container is not replenished in a timely manner. A visual indication of low water is not enough. Even in transparent vases one can forget to notice that the water level is too low. An audible alert is required, especially one that repeatedly sounds an alert.

The device is a rigid structure that is long and slender. The slender shape is important so that the device can be easily added or removed from a cut plant container having a narrow opening already full of cut plants. The lower end detects the presence or absence of water while the upper end emits an audible alert when no water is detected at the lower end. The device is long enough that the upper end (housing circuitry, alarm and batteries) remains above the normal high water level of the cut plant container to prevent possible water damage to these components.

Cavities within the device protect fragile components from handling and use damage, while also presenting a sleek outward appearance. Some cavities can be flooded: vented at top and bottom to allow water to seek its own level within the device. Flooded cavities provide additional protection of fragile components since sensors can be further from outer surfaces. Flooded cavities also permit debris and contaminants to be filtered from the water that is sensed giving a more robust operation. Dry cavities are ones in which water does not enter; they protect components from potential water damage.

The patent record does not address the innovative structural aspects of the present invention. Much prior art contains methods of providing a self-watering cut plant container. For example, Brankovic (U.S. Pat. No. 4,083,146) Hougard (U.S. Pat. No. 4,735,016) McDougall (U.S. Pat. No. 5,279,071) and Teufel (U.S. Pat. No. 6,766,614) discuss methods of making a cut plant container stay filled longer, but none discuss a self-contained low water alerting device.

Another part of the innovation of the present invention lies in applying various methods of sensing the presence or absence of water and circuitry that produces an audible alarm. Here the patent record provides many common techniques such as floats, pressure, electrical contact, capacitance, ultrasonic, microwave, thermal and optical ways to detect liquid level.

Low water alarms are common in industrial controls and for purposes of controlling liquid level. By far, the float method is the most prevalent in the patent record, especially those using magnetic switches to detect the level of the float. Fima (U.S. Pat. No. 4,069,405) and Applin (U.S. Pat. No. 3,849,771) use a float-magnet combination for detecting the water level of a swimming pool. Higo (U.S. Pat. No. 3,997,744) and Takai (U.S. Pat. No. 3,978,299) detect low engine oil levels with a float and magnetic switch. Eckert et al. (U.S. Pat. No. 6,375,430) and Lefervre (U.S. Pat. No. 5,562,003) use a float to detect the water level for a sump pump. Issachar (U.S. Pat. No. 6,028,521) uses a float with a magnet attached to detect the level in a cooking pot. Gallagher (U.S. Pat. Nos. 5,999,101, 5,945,913, 5,610,591) and Barnes (U.S. Pat. No. 4,771,272) use a float to trigger a switch for control purposes.

Other patents use floats for fuel tanks (Stiever U.S. Pat. No. 4,724,706), fuel storage tanks (Clarkson U.S. Pat. No. 4,459,584, Levine, et al. U.S. Pat. No. 4,962,661, Fling U.S. Pat. No. 5,042,319), dishwashers (Woolley, et al. U.S. Pat. No. 4,180,095, Payne U.S. Pat. No. 3,894,555, Zane U.S. Pat. No. 3,464,437), pet feeders (Mendes U.S. Pat. No. 5,845,600), car dip sticks (Steiner (U.S. Pat. No. 5,299,456), steam boilers (Piper, et al., U.S. Pat. No. 4,066,858). Others using floats to signal liquid level are Akeley (U.S. Pat. No. 3,702,910), Barton, et al. (U.S. Pat. No. 3,823,328), Bergsma (U.S. Pat. No. 4,609,796), Berrill (U.S. Pat. No. 5,565,687), Bridwell (U.S. Pat. No. 4,055,991), Clark, et al. (U.S. Pat. No. 5,426,271), Gismervik (U.S. Pat. No. 4,499,348), Ida (U.S. Pat. No. 4,473,730), Koebemik, et al. (U.S. Pat. No. 5,224,379), Lovett (U.S. Pat. No. 5,136,884), (Martin U.S. Pat. No. 5,144,700), Reinartz (U.S. Pat. No. 4,628,162), Sawada, et al. (U.S. Pat. No. 5,103,673), Tsubouchi (U.S. Pat. No. 4,458,118) and Weston (U.S. Pat. No. 4,395,605).

Pressure sensing is a common technique that uses a deflecting diaphragm to change the electrical impedance: Rader, et al. (U.S. Pat. No. 5,563,584) use a pressure sensor for medical infusion, Chen, et al. (U.S. Pat. No. 6,220,091) for semiconductor manufacturing and Kramer (U.S. Pat. No. 6,837,263), Marsh, et al. (U.S. Pat. No. 5,105,662) for general liquid level sensing. Pressure sensing to measure a few millimeters of water requires a large diaphragm and minute deflections. These requirements usually make pressure sensing too expensive for a mass-produced signaling device.

Another common type of liquid level alarm uses an electrical contact caused by the fluid itself. Chandler et al., (U.S. Pat. No. 5,229,751) use electrical contact for detecting the level in a coffee pot. Luteran (U.S. Pat. No. 3,944,845) uses high frequency electrical current to short contacts for level sensing of a conducting fluid. Sieron (U.S. Pat. No. 3,696,362) uses an electrical contact for signaling a low battery level, while Van Nort (U.S. Pat. No. 2,714,641) uses electrical contact for brake fluid level. Merenda (U.S. Pat. No. 4,796,017) and Gault (U.S. Pat. No. 5,428,348) detect the level of water in a Christmas plant stand by electrical contact. Hinshaw, et al. (U.S. Pat. No. 4,279,078) and Markfelt (U.S. Pat. No. 3,909,948) use electrical contact in a probe dropped into a well to find fluid presence.

Capacitance measurements are also used for liquid level sensing. Lenormand, et al (U.S. Pat. No. 6,844,743) and McIntosh (U.S. Pat. No. 6,842,018) measure the liquid level inside vessels with capacitor plates. Wotiz (U.S. Pat. No. 6,840,100) uses capacitive sensing to alarm a low level of water in a hydration pack. Fathauer, et al. (U.S. Pat. Nos. 5,245,873, 4,800,755 4,555,941) and Marsh, et al. (U.S. Pat. Nos. 5,223,819, 5105662, 5,048,335) measure the level in a vessel using a capacitance probe.

Sonic and ultrasonic liquid level sensing is very common as well. The usual way is to send a sonic pulse toward the liquid to reflect from the liquid-air interface and then receive the echo. The liquid level is directly related to the transit time between the pulse and its echo. Bower, et al. (U.S. Pat. No. 5,119,676), Viscovich (U.S Pat. No. 4,955,004) and Sluys (U.S Pat. No. 4,300,854) use pulse echo transit time. Telford (U.S. Pat. No. 4,890,490) Kikuta, et al. (U.S. Pat. No. 4,909,080), Caldwell, et al. (U.S. Pat. No. 4,984,449) send the pulseand echo through waveguides to measure liquid level. Fasching (U.S. Pat. No. 4,523,465), et al. and Gravert (U.S. Pat. No. 4,123,753) use one way acoustic waves from a sender in an oil well. Lynnworth, et al. (U.S. Pat. Nos. 4,320,659, 4,193,291), Webster (U.S. Pat. No. 5,031,451), Holroyd U.S. Pat. No. 5,015,995) and Scott-Kestin, et al. (U.S. Pat. No. 4,679,430) use a pulse of stress waves, acoustic vibrations or torsional waves in a vessel to measure the location of the liquid air interface.

Like ultrasonic liquid level measurement, microwave measuring often uses a similar pulse-echo transit time method. But instead of acoustic waves, microwaves reflect from the liquid air interface as shown by Otto, et al (U.S. Pat. No. 6,843,124), McEwan (U.S. Pat. No. 5,609,059) and Kielb, et al. (U.S. Pat. Nos. 5,672,975, 5,847,567) mostly for level measurement in a tank. Dalrymple, et al. (U.S. Pat. Nos. 5,305,237) and Edvardsson (U.S. Pat. Nos. 5,136,299, 5,070,730, 4,044,355) also show microwave pulse echo methods for level measurement.

In thermal methods, Anson, et al. (U.S. Pat. No. 5,377,299) uses a thermal low water sensor in a coffee pot. Waiwood (U.S. Pat. No. 3,955,416) measures the thermal time response of a heated temperature sensor in a hot water tank. Steele (U.S. Pat. No. 4,564,834) employs two heated thermistors with different thermal characteristics to detect liquid level.

Optical techniques for liquid level measurement include ways to reflect light from the liquid air interface. Secord (U.S. Pat. No. 5,164,606) reflects light through ports on a vessel. Harding (U.S. Pat. No. 4,345,180) reflects light from above the interface. Christensen (U.S. Pat. No. 4,745,293) uses retro-reflection through a fiber optic cable. Bobb (U.S. Pat. No. 5,367,175) employs a length of optical fiber that is heated by a laser to detect the location of a liquid interface.

The present invention uses floats, pressure, electrical contact, capacitance, ultrasonic, microwaves, vibrations, thermal and optical ways and to make a low-cost water level alarm. In addition, other novel techniques such as viscosity, density, beta rays and electrochemical means are used to notify low water level in a cut plant container.

### SUMMARY OF THE INVENTION

An aspect of the present invention is to provide an improved apparatus to audibly alert an attendant when the water in a cut plant container is too low.

Another aspect of the invention is to provide a low-water alert apparatus having a rigid structure that is long and slender with its length dimension taller than the normal depth of water in the cut plant container. The apparatus detects the presence or absence of water at one end and emits an audible alert at the other end of the structure.

Another aspect of the invention is to provide a low-water alert apparatus with enough durability to operate over several years but which can be cheaply manufactured at low cost.

Another aspect of the invention is to provide a low-water alert apparatus having a rigid structure that protects fragile components from handling damage within the housing of the apparatus.

Another aspect of the invention is to provide a low-water alert apparatus having internal cavities within the housing of the apparatus that protect fragile components from handling damage. Some cavities are flooded, allowing water from outside the apparatus to flow in and out through an opening at the bottom while allowing air to flow in and out through an opening above the normal water level. Other cavities are dry. These cavities can protect components from water damage.

Another aspect of the invention is to provide a low-water alert apparatus having a non-conducting housing. Sensing of water level can occur through non-conducting partitions between flooded and dry cavities within the apparatus.

Another aspect of the invention is to provide a low-water alert apparatus that works reliably despite contamination from debris in the cut plant container.

Another aspect of the invention is to provide a low-water alert apparatus that filters the water flowing into flooded cavities to reduce debris and contamination from the cut plant container.

Another aspect of the invention is to provide a low-water alert apparatus in a single self-contained package powered internally by batteries.

Another aspect of the invention is to provide novel methods for sensing the presence or absence of water next at the bottom of the slender structure. Some sensing methods are variations of common liquid level measuring, but adapted to apply to the slender, self-contained structure. Other sensing methods using the properties of viscosity, density, beta rays and electrochemical reactions are wholly new and innovative.

These and other aspects of the invention will become apparent in light of the detailed description of the invention which follows.

### BRIEF DESCRIPTION OF THE DRAWINGS

FIG. 1 is a diagrammatic isometric representation of the present device shown in normal usage in a container of cut plants.

FIG. 2 is a frontal cross-section representation of the device and container shown in FIG. 1.

FIG. 3 is a frontal cross-section representation of the device shown in FIG. 2 with diagrammatic representation of components of the device.

FIG. 4 is a frontal cross-section representation of the lower portion of the device shown in FIG. 3 with diagrammatic representation of components of the device used to sense the absence of water by thermal means.

FIG. 5 is a diagrammatic representation of an analog circuit which distinguishes the difference between water and air properties and sounds and audible alert on detecting the absence of water.

FIG. 6 is a diagrammatic representation of a self impedance circuit which distinguishes the difference between medium properties based on impedance differences of a single transducer.

FIG. 7 is a diagrammatic representation of a mutual impedance circuit which distinguishes the difference between medium properties based on coupling between two transducers.

FIG. 8 is a frontal cross-section representation of the lower portion of the device shown in FIG. 3 with diagrammatic representation of components of the device used to sense the absence of water by vibration, viscosity and density means.

FIG. 9 is a frontal cross-section representation of the lower portion of the device shown in FIG. 3 with diagrammatic representation of components of the device used to sense the absence of water by acoustic means.

FIG. 10 is a frontal cross-section representation of the lower portion of the device shown in FIG. 3 with diagrammatic representation of components of the device used to sense the absence of water by electromagnetic (capacitance, RF and microwave) means.

FIG. 11 is a frontal cross-section representation of the device shown in FIG. 3 with diagrammatic representation of components of the device used to sense the absence of water by microwave means.

FIG. 12 is a frontal cross-section representation of the lower portion of the device shown in FIG. 3 with diagrammatic representation of components of the device used to sense the absence of water by optical means.

FIG. 13 is a frontal cross-section representation of the lower portion of the device shown in FIG. 3 with diagrammatic representation of components of the device used to sense the absence of water by radiation means.

FIG. 14 is a frontal cross-section representation of the lower portion of the device shown in FIG. 3 with diagrammatic representation of components of the device used to sense the absence of water by electrical contact means.

FIG. 15 is a frontal cross-section representation of the lower portion of the device shown in FIG. 3 with diagrammatic representation of components of the device used to sense the absence of water by electrochemical means.

FIG. 16 is a frontal cross-section representation of the lower portion of the device shown in FIG. 3 with diagrammatic representation of components of the device used to sense the absence of water by float means.

FIG. 17 is a frontal cross-section representation of the lower portion of the device shown in FIG. 3 with diagrammatic representation of components of the device used to sense the absence of water by pressure means.

### DETAILED DESCRIPTION OF THE PREFERRED EMBODIMENTS

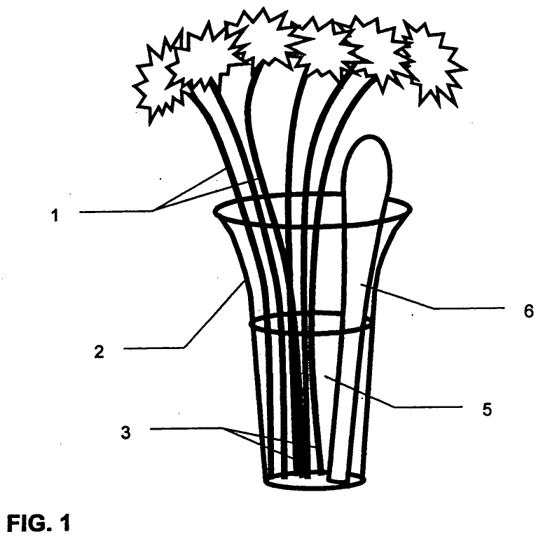

In the following description, cut flowers are used to explain the invention. However, the same apparatus applies to other cut plants as well. FIG. 1 shows cut flowers 1 in a container 2 used for watering and keeping the cut flowers in an upright position. The cut ends 3 of flowers 1 are placed in water 5 of container 2 to keep its cut ends 3 wet. Often plant nutrients are placed in the water 5 of container 2 to feed the plant. This invention applies specifically to water 5 and not other fluids, although water 5 may also contained dissolved minerals, contaminants and nutrients.

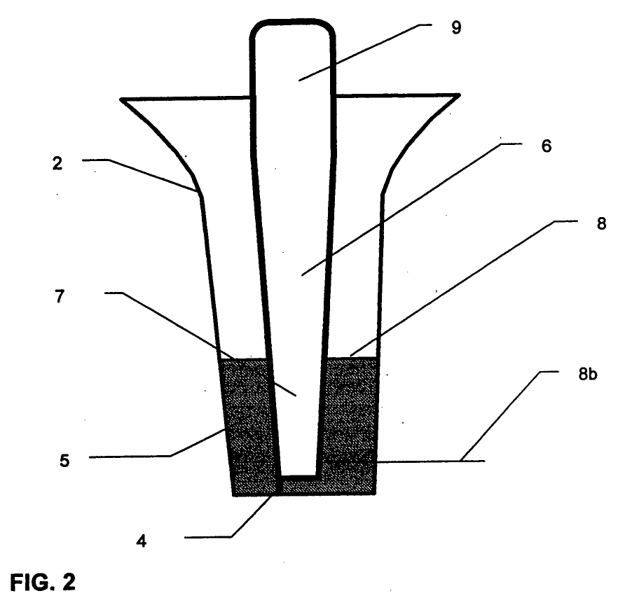

Device 6, the object of the invention, has two components as shown in FIG. 2. Water sensing component 7 which senses the presence of water 5 or depth of water level 8, and alarm component 9 which signals an audible alarm when the level 8 drops below an “alert level” 8b, the minimum water level 8 when an audible alert is sounded. Standoff 4 keeps the bottom tip of device 6 away from any sediment at the bottom of container 2. Despite cavities contained within the housing, device 6 has enough weight to overcome buoyancy forces, allowing it to sink in water 5 to rest on standoff 4.

The alarm component 9 is combined into a rigid structure with sensing component 7 as shown. The entire device 6 is rigid enough to place unsecured in container 2, holding device 6 in an approximately vertical position by leaning against container 2 or a cut plant. The housing is a non-conductor, typically plastic, which can be molded into a desirable design of device 6.

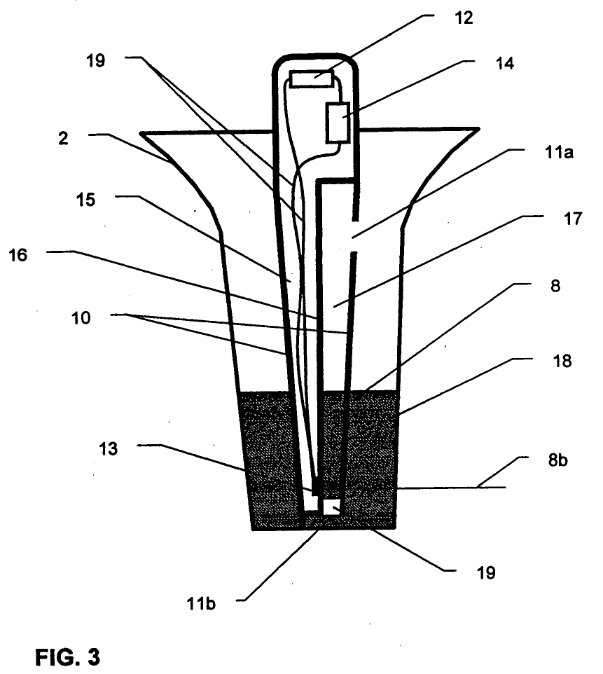

FIG. 3 shows a cutaway of a typical device 6. Watertight cavity 15 is separated from water 5 by non-conducting inner partition 16. Cavity 15 is dry; it contains sensor 13 connected to battery 12 and circuit 14 via wires 19. Sensor 13 detects the presence of water 5 through partition 16 by various means.

Adjacent to cavity 15 is cavity 17, formed by housing 10 and the inner partition 16. Cavity 17 is a flooded cavity with two openings 11 to let water flow inside. One opening 11a is near the top of device 6, above the highest water level 8, lets air to flow in and out. The other opening 11b is at the bottom of the device, below alert water level 8b, lets water flow in and out.

Since cavity 17 is open at top and bottom, if it is placed in container 2, water will flow into cavity 17 via opening 11b until the water level 18 inside equals the water level 8 outside. Cavity 17 is a “flooded cavity”. Used here, it means a cavity that floods with water when device 6 is placed in water 5 of a container 2. The water level inside a flooded cavity matches the water level of the container 2 in which it is placed. Filter 19 located at the bottom opening 11b, assures that water flowing into cavity 17 is relatively clean.

In an alternative embodiment, sensor 13 can be attached to housing 10 rather than partition 16, detecting the presence of water 5 outside device 6 through housing 10. While such an embodiment is viable for many sensing methods, the use of flooded cavity 17 lets water 18 be filtered clean for those sensing methods susceptible to contamination. In addition, cavities 15 and 17 are internal to housing 10, giving structural protection to a fragile sensor 13 that can be easily damaged by contact.

In the following discussion of different sensors 13, understand that in most high volume products today, a component such as sensor 13 is usually a very tiny silicon chip or die that is mass-produced in modern wafer processing facilities. A single sensor 13 might be one of a quarter million other sensors on a single wafer. These dies are attached to a substrate that is often a flexible printed circuit board (fPCB) rather than wires 19 shown on FIG. 3. Conducting paths from the sensor die to the fPCB and from the FPCB to other circuitry are bonded automatically leaving a sensor robustly connected to circuitry such as alarm circuitry 14.

The purpose of sensor 13 is to detect a “low water” condition electrically. Here, a low water condition means that the water level 8 has dropped below alert water level 8b, determined by the location of sensor 13. Essentially the task of the sensor is to reliably determine whether water or air exists in container 2 adjacent to sensor 13. Note that alert level 8b is designed to be somewhat above the bottom of container 2 to assure that the cut ends 3 of cut plants 1 always are below water level 8. The audible signal occurs before the container is completely empty, giving an attendant time to refill container 2.

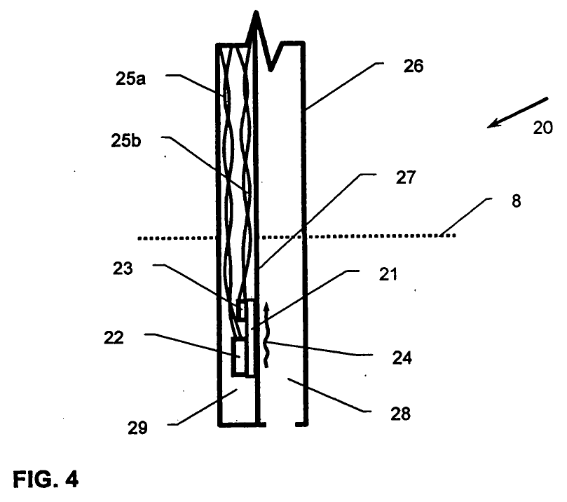

Thermal: FIG. 4 shows sensing component 7 as component 20 where sensor 13 is based on thermal effects. Only the lower sensing component of device 6 (FIG. 2) is shown for simplification. A filter (not shown) such as filter 19 (FIG. 3) can be used to keep debris from entering cavity 28. Sensor 13 is bonded by adhesive to partition 27, between dry cavity 29 and flooded cavity 28. Sensor 13 is composed of resistor heater 22, conductor 21 and thermistor 23, a resistor that varies with temperature. The preferred embodiment uses a positive temperature coefficient (PTC) thermistor having an electrical resistance that increases with increasing temperature. Wires or FPCB 25 connect heater 22 and sensor 23 to alarm circuitry 14 (not shown).

The thermal sensor uses the large difference in heat transfer between air and water to detect when water level 8 is too low. Metal conductor 22 is in good thermal contact with partition 27, with heater 22 and with thermistor 23. When heater 22 is turned on, it transfers heat to conductor 21 that in turn conducts heat to thermistor 23. Since conductor 21 lies in dry cavity 29, heat loss from the conductor into cavity 29 is minimal.

Partition 27 is designed to be thin (about 0.5 mm) so that heat will conduct easily through partition 27 despite its being plastic, a poor thermal conductor. In addition the area of conductor 21 in contact with partition 27 is large to assure good thermal contact with partition 27. Conductor 21 loses heat 24 by conduction to partition wall 27 and then by natural convection to the medium in cavity 28.

If the medium adjacent to conductor 21 is water, heat 24 is transferred easily by convection into flooded cavity 28. In doing so, the temperature of conductor 21 rises little and thermistor 13 never gets very hot. However, if the medium is air, heat loss 24 by natural convection from partition 27 is very low. Essentially conductor 21 is insulated: it can't lose heat by convection to either cavity 28 or 29 and it can't lose heat by conduction along the length of partition 27. As a result, heater 22, conductor 21 and thermistor 23 all rise in temperature, signaling that water level 8 has dropped below conductor 21.

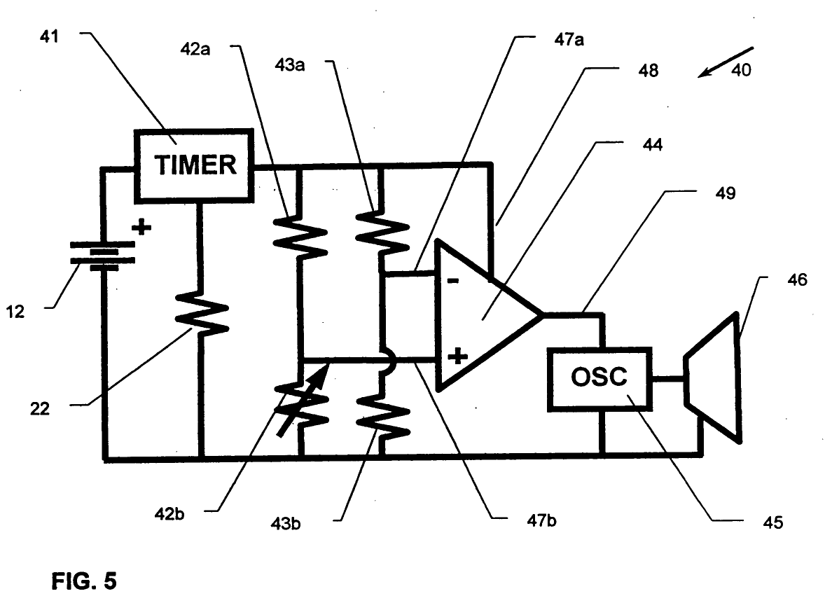

An example of sensing circuit 14 is shown in FIG. 5 as circuit 40. Circuit 40 has a timer 41 powered by battery 12 that controls the sequencing of events. Timer 41 uses a timing source such as an RC relaxation oscillator or a crystal oscillator to produce a short period signal. In a common implementation, the oscillator drives a binary countdown register such that each successive pin of the register has a period twice that of the previous pin. By combining timer output signals with different AND logic gates, a 14-pin countdown timer can produce a signal for nearly any time period or any time duration desired.

In the device 20 (FIG. 4), heater 22 is first turned on by timer 41. Heater 22 is held on for a short duration such as one second and then turned off. The signal that turns off heater 22 also turns on the sensing circuit composed of resistors 42 and 43, comparator 44, oscillator 45 and speaker 46. When it is turned on by timer 41, current flows from battery 12 through load resistor 42a. The variable resistor 42b represents the variable resistance of thermistor 23 (FIG. 4). Resistor 42b has a low resistance value (i.e., low temperature) with a water medium and a high resistance value when air is the medium adjacent to conductor 21.

Differential comparator 44 has differential inputs 47. When the voltage at 47b is greater than at 47a, the output 49 of comparator 44 approaches supply voltage, turning on oscillator 45 and energizing speaker 46. When the voltage at 47a is greater than at 47b, output 49 of comparator 44 approaches ground, turning off oscillator 45 and speaker 46. Battery 12 also powers comparator 44 by supply wire 48. Resistors 43 form a voltage divider that fixes the trigger point of comparator 44. For example, if resistor 43a and 43b had the same value, the voltage at input 47a is fixed at half the supply voltage of battery 12.

When air is adjacent thermistor 42b, it has a high resistance and the voltage at input 47b goes higher than that at input 47a. This raises the output voltage of comparator 44 turning on oscillator 45 and emitting sound from speaker 46, thus signaling that water level 8 is too low. When water is adjacent thermistor 42b, it has a low resistance value dropping the voltage at input 47b to comparator 44 below that at input 47a. This lowers the output of comparator 44 turning off oscillator 45 and halting sound from speaker 46. Hence when water is present, no alarm sound occurs.

Circuit 14 is essentially a resistive bridge circuit with resistors 42a and 42b forming two sides of the bridge and resistors 43a and 43b forming the other two sides. The comparator 44 via its inputs 47a and 47b detect any imbalance of the bridge caused by variation in thermistor 42b.

Each time heater 22 turns on and then off, the temperature of thermistor 23 is measured. If it is higher than a threshold determined by resistors 43, then circuit 14 alarm gives an audible alert. Each cycle of “heater on, heater off, measure temperature” occurs at regular intervals, perhaps once a minute in order to prolong the life of battery 12 and to allow thermistor 23 to cool to ambient.

Impedance: Besides thermal sensing, other sensing methods will now be described to distinguish the presence of water level 8 above the alert level 8b. These other methods can be best understood by considering self impedance sensing and mutual impedance sensing.

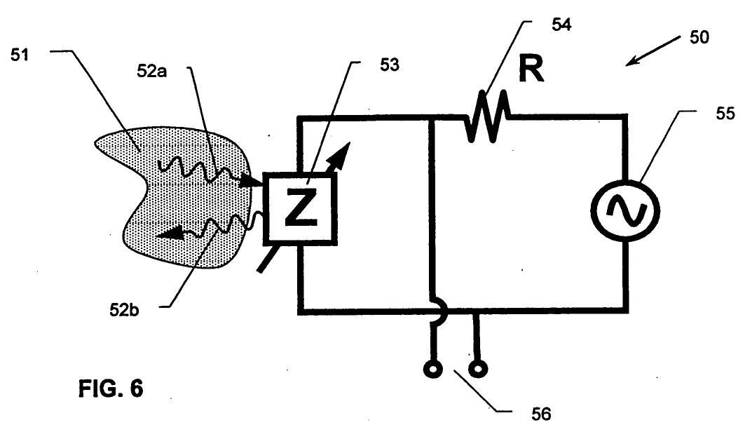

Self impedance sensing measures the self-impedance of a transducer which is altered by a medium. FIG. 6 shows the generalized case of a medium 51 adjacent to transducer 53. Transducer 53 transforms electrical energy it receives from electrical source 55 through resistor 54 at some driving frequency into another energy form such as electromagnetic energy, acoustic energy and other energy forms. The converted energy interacts with medium 51 to change its conversion efficiency to the other energy form.

Changes in medium 51 can be detected by measuring the electrical impedance of transducer 53.

The voltage signal across terminals 56 is characterized by its phase and amplitude. Typically resistor 54 is chosen such that the operating frequency of circuit 50 is near the circuit's break frequency to maximize the change of phase and amplitude with changes in medium 51. Other circuit elements can replace resistor 54. For example, if an inductor L in series with a resistor R is substituted for resistor 54 and transducer 53 is a capacitor C, circuit 50 becomes an LRC circuit. If source 55 is tuned to the resonance of the LRC circuit, the amplitude and phase at terminals 56 become quite sensitive to changes in medium 51.

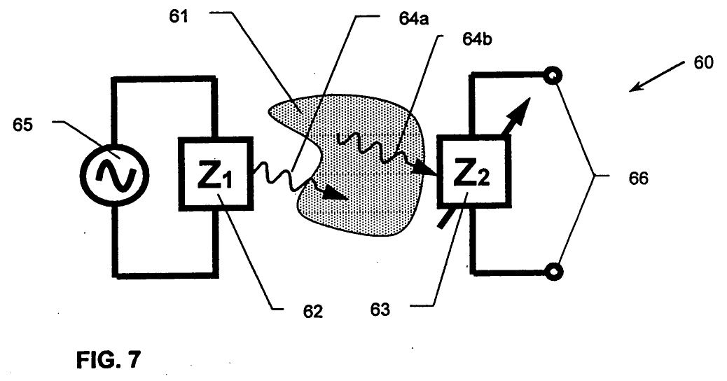

Circuit 50 is termed “self-impedance” because transducer 53 itself interacts with medium 51 (i.e., both sends and receives energy from medium 51). FIG. 7 shows circuit 60 termed “mutual impedance” because two transducers 62 and 63 interact with medium 61. One transducer 62 acts like a transmitter. It converts electrical energy from voltage or current source 65 to another energy form 64a that interacts with medium 61. The other transducer 63 acts like a receiver. It converts energy 64b into electrical energy that can be detected at terminals 66.

Mutual impedance circuit 60 measures the mutual impedance between a “transmitter” transducer and a “receiver” transducer. Depending on medium 61, the two transducers 62 and 63 couple with each other by different amounts. Good coupling means that the energy transmission path through medium 61 is efficient.

Whether self-impedance circuits 50 or mutual impedance circuits 60, the point of using these circuits in the present invention is to determine property differences in the medium 51 or 61. Since the medium is either air or water, many different properties can distinguish between these two media. For example, water has a density 1000 times that of air. A transducer sensitive to density such as a beta ray transducer could expect large impedance changes when used in circuits 50 or 60. Other properties that have large differences between air and water are dielectric constant, viscosity, index of refraction and microwave absorption among others.

Both self impedance circuits 50 and mutual impedance circuits 60 can be used with alarm component 9 to detect the level 8 of water adjacent to device 6 (FIG. 2). In each case, transducers 53 (FIG. 6) or 62 and 63 (FIG. 7) need to be located near enough to water 5 to significantly change their impedance as the medium changes from water to air. They need not be physically immersed in water 5 since many transducers can interact with medium 51 (FIG. 6) or 61 (FIG. 7) through the walls of a non-conducting enclosure or through a partition between a flooded cavity and a dry one.

Now follows a brief description of both self-impedance and mutual impedance circuits. Often a particular type of transducer can be used in both a self-impedance circuit and also a mutual impedance circuit. For brevity, only one of the circuits will be shown for a particular transducer type. One skilled in the art could see how both circuits are suitable.

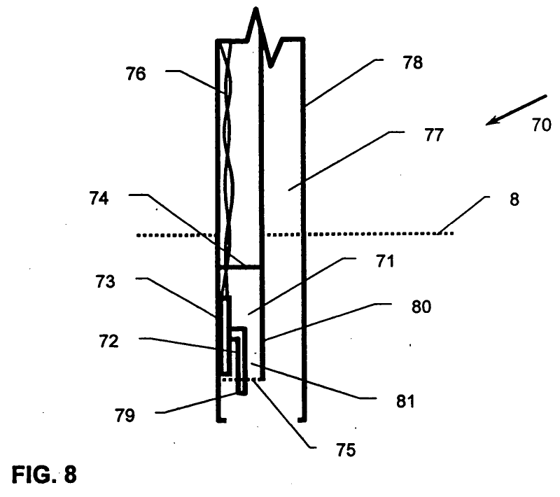

Vibration: FIG. 8 shows a self-impedance vibrational sensing component 70, another sensing component 7 that can be used to signal a low water level 8. Transducer 73 is protected from handling damage by housing 78. Flooded cavity 77 can optionally have a filter (not shown) such as filter 19 (FIG. 3) to further protect transducer 73.

While solenoids are suitable for the driver of vibrational transducer 73, piezo-ceramic or piezo-electric transducers are the preferred embodiment since they are inexpensive and easily assembled. Transducer 73, commonly made of PZT (lead zirconate titanate) or PVDF (polyvinylidene fluoride), produce a slight deflection normal to their plane when a voltage is applied via wires 76. Usually fabricated in a flat thin disk, transducer 73 is bonded on its periphery to the wall of partition 80. Note that transducer 73 has no sliding parts which could produce inaccurate measurements. The vibrations that they produce come from flexing of transducer 73.

Cavity 71 has been designed to protect transducer 73 from contact with water that would compromise its performance. Barrier 74 blocks the flow of air from the top portion of cavity 71 but allows wires 76 (or FPCB) to pass through barrier 74 by good sealing of wires 76. As such, when device 6 is placed in water 5, a pocket of air is trapped in cavity 71 and it remains dry despite being below water level 8. The air-water interface 75 separates dry cavity 71 from flooded cavity 77. Note that cavity 77, unlike cavity 71, is vented. Vent 11a (FIG. 3) assures that no air is trapped in cavity 77 and the water level inside cavity 77 is the same as the water level 8 outside housing 78.

Vibrational transducer 73 has a vane 72 attached to its center such that a portion of the vane penetrates air-water interface 75 below transducer 73. To give the largest impedance change, transducer 73 is driven at its resonate frequency in air. That is, when water level 8 drops below tip 79 of vane 72, the device resonates when air surrounds tip 79. However when water surrounds the tip 79 of vane 72, the amplitude of vibration is much less than with air.

Wires 76 are connected to a self-impedance circuit such as circuit 50 (FIG. 6). The self-impedance changes dramatically when water level 8 drops below tip 79. That self-impedance signal as measured by contacts 56, produce a signal giving an audible alarm from device 6.

Viscosity: Changing the geometry of the vane 72 can improve the response of sensing component 70. For example, by locating the vane close to the housing 78, makes sensing component 70 sensitive to the viscosity difference between air and water. When water is present in gap 81, the damping of the vane transducer combination is much more than if air is in gap 81. Again, this change can be determined by measuring the self-impedance of transducer 73.

Density: Another example is to make the portion of vane 72 below air water interface 75 large. As such, any motion of the transducer-vane combination entrains the medium below the interface 75. The degree of entrainment is strongly related to the density of the medium. Water, whose density is 1000 that of air, has a much larger effect on the self-impedance of transducer 73 than does air. If water level 8 drops below the tip 79 of vane 72, then only small entrainment forces occur.

Another variation of the vibrational transducer 70, combines sensing component 7 with alarm component 9 (FIG. 3). Again the driving frequency is chosen as the resonant frequency of transducer 73 in air. Gap 81 is chosen to be very small (0.1 mm or less). Driven at its resonant frequency in air, vane 72 will clatter against partition 80 giving an audible signal that water level 8 is too low. When water surrounds tip 79, viscosity and water entrainment will reduce the vibrational amplitude and keep vane 72 from emitting an audible alarm.

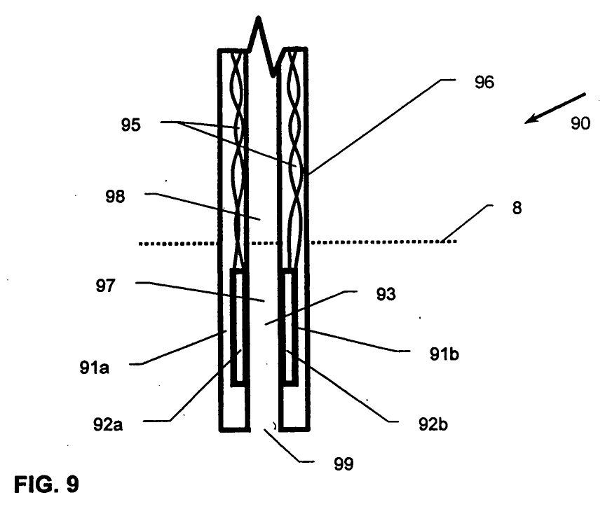

Acoustic: Sensing component 7 is shown as acoustic sensing component 90 in FIG. 9. It uses a mutual impedance circuit 80 employing two disk-shaped acoustic transducers 92a and 92b attached inside cavities 91a and 91b respectfully. The transducers are made of PZT or PVDF as discussed with reference transducer 73 (FIG. 8). Cavities 91 remain dry regardless of level 8 of water; central cavity 93 is a flooded cavity with water flow through opening 99 and air flow through an opening in the top of cavity 93 (not shown). Cavity 93 has water below level 8 and has air above level 8. A filter in opening 99 (not shown) similar to filter 19 (FIG. 3) can be used to reduce debris and contaminants from cavity 93.

Transducers 92 are bonded on their periphery to the walls of enclosure 96. Used as a transmitter 92a, the disk and enclosure wall 92 radiate acoustic energy through its attachment wall normal to the disk's plane. The maximum energy is directed along the axis of the disk toward transducer 92b. Usually the highest acoustic energy is transmitted when the disk-wall combination is electrically excited close to its mechanical resonant frequency. Similarly, when the disk is used as an acoustic receiver 92b, it is most sensitive to acoustic energy along the disk's axis when the frequency of the acoustic energy is close to its disk/wall mechanical resonance.

Two transducers 92 placed close to each other along the same axis (the disks' planar surfaces are parallel) form an acoustically coupled pair. Sinusoidal electrical voltage applied through wires 95 drives transmitter 92a at its resonance. Receiver 92b converts the acoustic energy impinging on its surface into an electrical voltage detected through wires 95. The coupling coefficient (the ratio of applied voltage to received voltage) depends on the medium in cavity 93 between the disks. At some frequencies of operation, water medium 97 couples transducers 92 much better than air medium 98.

Coupled transducers 92 can be used as water sensing component 7 (FIG. 2) to detect when water level 8 drops below alert level 8b. Electrical circuitry (not shown) detects the coupling between the transmitter receiver pair 92 by sensing the output voltage of the receiver transducer 92b during the time that transmitter transducer 92a is transmitting acoustic energy. If a high AC voltage is detected, the medium is water and no alarm is sounded. However, if a low voltage is detected, the medium is air and the alarm is sounded to signal that water level 8 is too low.

FIG. 9 also shows the preferred embodiment of acoustic sensing circuit 90. Here, transmitter 92a and receiver 92b are not themselves exposed to the medium 97 and possible corrosion during operation. Rather, transducers 92 are bonded to a water-impermeable wall of enclosure 96 that protects transducers 92 from water and handling damage.

Although FIG. 9 shows a mutual impedance arrangement like circuit 60 in FIG. 7, a self-impedance arrangement is also possible by eliminating transducer 92b and cavity 91b, leaving only transmitter 92a and cavities 91a and 93. Using a single transducer 92a makes a self-impedance circuit like circuit 50 in FIG. 6. The transducer 92a, along with the wall of enclosure 96 through which it transmits, is driven at a frequency set at the transducer/wall resonant frequency when the medium in cavity 93 is water. If water level 8 is below transducer 92a, the impedance of the transducer changes, signaling a low water condition.

An even simpler circuit 90 is to design transducer 92a in a self-impedance circuit to resonate with its enclosure wall in air. When water is the medium in cavity 93, little audible sound is heard because the water changes the natural frequency of transducer 92a to an inefficient one. When water level 8 drops below transducer 92a, it is designed to emit an audible frequency, one that can be heard easily by the plant's attendant. Hence transducer 92a can act as both sensing component 7 and alarm component 9.

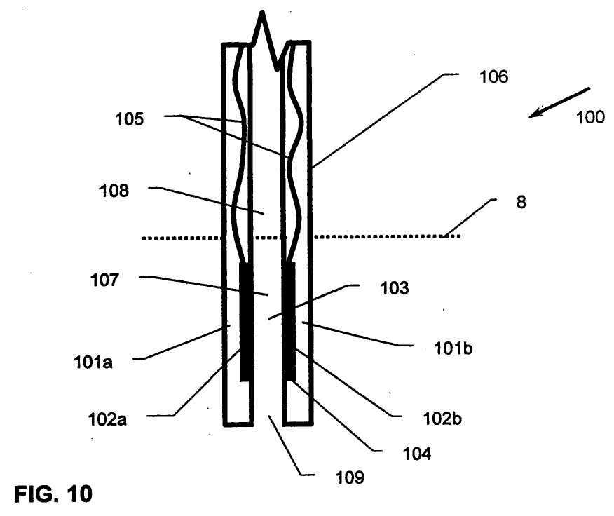

Electromagnetic: FIG. 10 shows the sensing component 7 of device 6 as electromagnetic sensing circuit 100 set up in a mutual impedance configuration. Sensing component 100 has a transmitting antenna 102a that transmits electromagnetic fields through the non-conducting interior wall of enclosure 106, through the medium in cavity 103 and through the non-conducting interior wall of enclosure 106 adjacent to antenna 102b. On the other side of cavity 103, receiving antenna 102b picks up the electromagnetic fields transmitted by transmitter 102a. If the medium is air, receiver 102b will be strongly coupled to transmitting antenna 102a. If the medium is water, its high dielectric constant and conductivity will prevent much of the electromagnetic energy from being transmitted to receiver 102b. The dielectric constant of water can be 30 times greater than that of air; its electrical conductivity is more than 100 times that of air under the worst conditions.

Cavities 101a and 101b house the antennas under dry conditions: no water is present. The level of water in flooded cavity 103 follows water level 8 via vent 109 in the bottom of the cavity 103 and a vent on the top of cavity 103 (not shown). Connections 105 are usually coax, stripline, microstrip or other high frequency transmission means which connect antennas 102 to impedance measuring circuitry like that of FIG. 7. Note that the antennas 102 can also be fabricated from flexible printed circuit board such that wires 105 and antennas 102 are the same component.

Electromagnetic sensing depends on the frequency. At low frequency (less than a MHz), capacitive sensing sets up electrostatic fields. They are called “static” because the fields do not propagate as waves. Higher frequency electromagnetic sensing is characterized by electrodynamic fields, those that have a wavelike propagation. At higher frequencies in the MHz range (called RF for radio frequency), changes in the electromagnetic characteristics of a medium can be used to determine whether the medium is air or water. At frequencies above a GHz, called microwave frequencies, again the changes in electromagnetic characteristics of different mediums such as air or water can be easily detected by changes in the coupling between transmitting antenna 101a and receiving antenna 101b.

The topology of FIG. 10 is essentially the same whether the electromagnetic energy is static fields or electrodynamic waves. However, there are also differences in the circuitry 100 depending on the frequency of electromagnetic energy.

Capacitive: For low frequency operation, the antennas are simply plates or foil bonded to the inner wall of cavities 101 for handling protection. Testing has shown that the width of the capacitive plates 102 (i.e., into the page in FIG. 10) must have a minimum dimension several times the distance between plates 102, the width of cavity 103. When water blocks the path between transmitter plate 102a and receiver plate 102b, the amplitude of sinusoidal voltage from plate 102b is very low compared to when air is between the plates and good coupling results.

In addition, if antenna plates 102 run the entire length of cavities 101, the coupling between antennas 102 can be made nearly proportional to the amount of antenna length that is adjacent to water filled cavity 103. Instead of simply measuring the water level 8 when it is below alert level 8b, the water level 8 at any location is determined.

Radio Frequency and Microwave: At RF frequencies between a MHz and a GHz, connecting wires 105 become part of antennas 102 in transmitting or receiving electromagnetic waves across cavity 103. For microwave frequencies above 1 GHz, connections 105 to antennas 102 must be microwave coax, stripline or microstrip transmission lines to reduce losses along their length. The proper design of RF antenna or microwave patch antennas 102 can also allow them to operate over a large length of cavity 103. Like capacitive sensors 102, RF and microwave antennas 102 can find a rough measure of the location of water level 8 rather than simply its closeness to alert level 8b.

In a self-impedance configuration of electromagnetic transducer 100, the receiver antenna 102b and cavity 101b are eliminated. The single antenna 102a transmits electromagnetic fields through cavity 103 or housing 106 that are affected by the water medium. The transmitting antenna 102a is driven at a frequency compatible with its detecting circuitry giving changes in self-impedance similar to the description of the self-impedance configuration of acoustic transducers 92 (FIG. 9). If water level 8 is below transducer 102a, the impedance of the transducer will change with air as the surrounding medium, signaling a low water condition to alarm component 9.

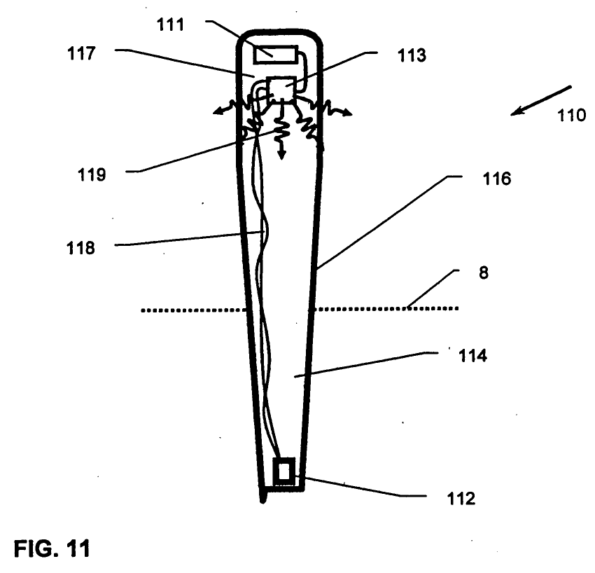

A variation of the self-impedance configuration is shown in FIG. 11. It uses a radio frequency transmitter similar to an RFID tag (radio frequency identification tag) as transmitter antenna 113 at the top 117 of device 110. Receiver 112 is powered by supply wires 118 from circuit 113 as shown in FIG. 11. Alternatively, receiver 112 can receive power from the transmitted signal itself as RFID tags do. In another alternative, antenna 112 can simply be an RF antenna of circuit 113. Circuit 113 also includes alarm components such as comparator 44, oscillator 45 and speaker 46 of circuit 40 to signal an audible alert.

At electromagnetic frequencies in the high MHz to low GHz range, water strongly absorbs electromagnetic waves 119 sent by transmitter circuit 113. When water level 8 is above the transmitter circuit 113, radio waves can only be transmitted effectively through the long column of air formed by dry cavity 114 (i.e., water displaced by sealed enclosure 116). The diameter of cavity 114 is typically 15 mm compared to the operating wavelength of about 300 mm for 1 GHz microwaves. Under these conditions, the penetration of waves into air cavity 114 is approximately one column diameter (or 15 mm in the preferred embodiment).

When water level 8 is more than about one diameter above receiver 112, electromagnetic waves can not receive electromagnetic waves 119 from transmitter circuit 113. Waves 119 sent from transmitter circuit 113 are absorbed by the water surrounding receiver 112. Circuit 113 receives no response from receiver 112 and no alert is sounded. But when water level 8 drops close to receiver 112, electromagnetic waves 119 are no longer attenuated in the vicinity of receiver 112. When circuit 113 receives a signal from receiver 112, it drives the speaker to make a low-water alert.

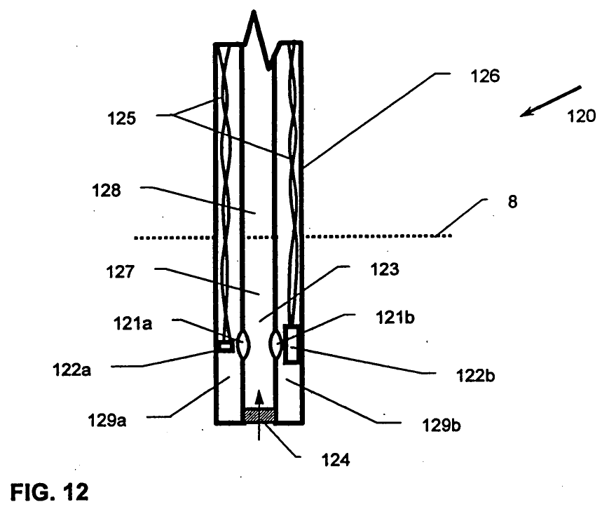

Optical: Optical transducers are a class of electromagnetic transducers operating at higher frequencies than microwaves; wavelengths are typically in the visible and infrared range between 400 and 2000 nm. FIG. 12 shows an optical transmitter-receiver configuration 120 as sensor component 7 of device 6. Transmitter 122a is a light source such as a light-emitting diode (LED) and receiver 122b is a light detector such as a photocell or photodiode. As in previous designs, transmitter 122a and receiver 122b are housed in water-tight cavities 129 to keep components 122 and wires 125 dry. Water 127 can flow freely into central flooded cavity 123 until its level matches that of water level 8 outside enclosure 126. Filter 124 keeps the water inside cavity 123 free from contaminants that might interfere with the transducer's operation.

Lenses 121a and 121b are transparent components that focus the light from transmitter 122a onto receiver 122b. The focusing is done with water 127 as the medium in cavity 123, i.e., when the housing is under water. Since the index of refraction of water is N=1.3 compared to air at N=1.0, when water level 8 drops such that air medium 128 fills the gap between lenses 121, light from transmitter 122a will not focus on detector 122b. Receiver 122b outputs a voltage in proportion to the light that it receives: high for water, low for air.

To detect the variable voltage of receiver 122b, modifications are made to detecting circuit 40 (FIG. 5). First, receiver 122b replaces variable resistor 42b in circuit 40 and load resistance 42a is removed. Second, heater 22 is eliminated. When the medium between lenses 121 is water, voltage from receiver 122b is high, preventing comparator 44 from driving oscillator 45 and speaker 46. No sound is made. When the medium is air, little light is focused on receiver 122b resulting in a much smaller voltage at connection 47b to comparator 44. If the voltage becomes lower than that set by resistors 47, comparator 44 turns on and drives speaker 46 to signal an audible alert.

Radiation: Radiation based electromagnetic frequencies with a still higher frequency than optical frequencies can also determine a low water condition. Radiation waves, more commonly called “rays”, come in three general categories based on their energy: alpha, beta and gamma rays. Beta rays are the most suitable for a low-cost transducer. Alpha rays are not energetic enough to penetrate even a thin layer of plastic partition 138 of housing 136. Gamma rays are too energetic, requiring extensive shielding to protect people from radiation damage. Beta rays (energetic electrons) can both penetrate partition 138 and do not require much shielding.

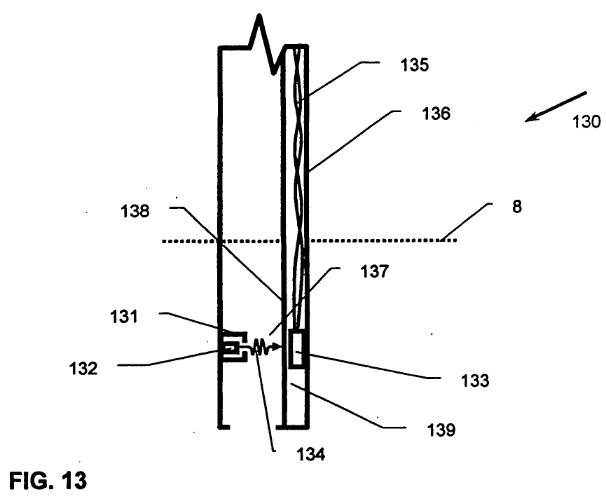

FIG. 13 shows sensing component 7 of device 6 as transducer 130. It uses an isotope beta ray source 132 which transmits beta rays 134 across flooded cavity 137 which could contain either water or air. The receiver 133 is a solid state detector made, for example, from cadmium zinc telluride (CZT). Like a Geiger counter, a CZT detector increases its voltage output when it detects beta rays. It is positioned to receive beta rays 134 from source 132; shielding 131 shields the surroundings from extraneous beta rays. Detector 133 lies in dry cavity 139 separated from the medium in flooded cavity 137 by partition 138 of housing 136.

Wires 135 connect to a circuit similar to circuit 40 (FIG. 5), reconfigured for a variable voltage source similar to that of optical detector 120 discussed above in relation to optical transducers. In addition, comparator 44 is reversed. That is, variable voltage source replacing variable resistor 42b is connected to the positive terminal 47a while the resistor array 43 is connected to the negative terminal 47b. When the water level 8 is above source 132 and detector 133, beta rays 134 are absorbed by the water and the detector has a low voltage output. When water level 8 drops below source 132 and detector 133, beta rays 134 from source 132 are no longer blocked by water in cavity 137. Detector 133 sends a high voltage signal to modified circuit 40 that triggers comparator 44 causing speaker 46 to sound a low-water alert.

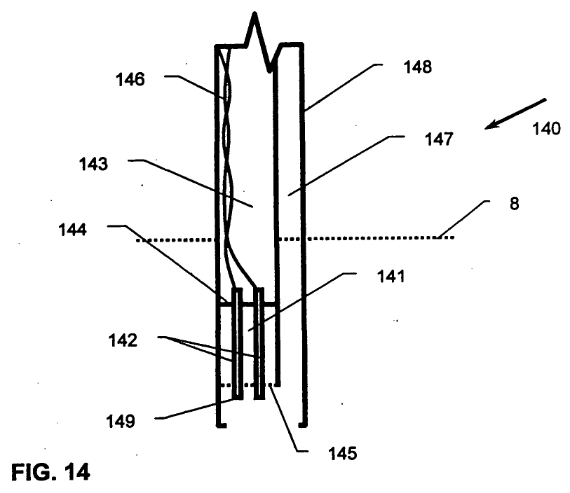

Electrical Contact: Water level 8 can also be detected using electrical contact with water 5. FIG. 14 shows the sensing component 7 of device 6 as sensing component 140. Non-conducting housing 148 has three cavities: 141, 143 and 147.

Cavity 141 is a dry cavity similar to dry cavity 71 of vibrational transducer 70 (FIG. 8). It is dry because barrier 144 blocks the flow of air from leaving cavity 141 but allows electrical contacts 142 to pass through barrier 144 by good sealing of contacts 142 to barrier 144. As such, when device 6 is placed in water 5 or container 2 is filled with water 5, a pocket of air is trapped in cavity 141 and the cavity remains dry despite being below water level 8. Tips 149 of electrical contacts 142 extend through air-water interface 145 formed by the bottom surface of the air pocket in cavity 141 below barrier 144.

Cavity 143 is dry and contains the tops of contacts 142 to which wires 146 connect to a circuit such as circuit 40 (FIG. 5). Cavity 147 is a flooded cavity. Water flows into and out of cavity 147 through openings below water level 8. Air flows in and out of cavity 147 through a vent (not shown) above water level 8 at the top of cavity 147.

When water level 8 rises, cavity 147 fills such that the level inside cavity 147 is at the same level as water level 8 outside housing 148. As it rises, the air pocket is trapped in cavity 141. Yet tips 149 of contacts 142 penetrate through interface 145 into the water below interface 145. As such, the electrical resistance between contacts 142 drops from a high value when air surrounds contact tips 149 to a low value when water surrounds tips 149. Note that the air pocket in cavity 141 keeps the bases of contacts 142 (the portion above tips 142) from contamination, reducing errors in alerting a low water condition. Contamination from water 5 can also be reduced by a filter on the inlet opening, similar to filter 19 of opening 11b (FIG. 3).

The electrical resistance of contacts 142 via wires 146 is the variable resistance 42b of circuit 40 (FIG. 5). When the resistance is high (air surrounds contact tips 149), comparator 44 triggers and powers oscillator 45 which produces a sound alert from speaker 46. When the resistance is low (water surrounds contact tips 149), the voltage into connection 47b of comparator 44 is too low compared to the voltage on connection 47a set by resistors 43. Comparator 44 sends no current to oscillator 45 and speaker 46 makes no sound. Again, a low water condition results in an audible alarm.

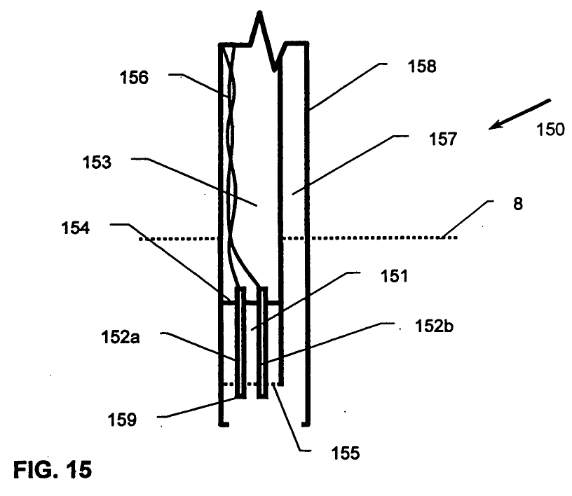

Electrochemical: FIG. 15 shows schematically the sensing component 7 of device 6 as component 150. Contacts 152 are made of two materials having opposite galvanic potential, such as zinc for contact 152a and copper for contact 152b. Wires 156 connect contacts 152 to a modified sensing circuit 40 (FIG. 5) which uses a comparator 44 to detect a voltage difference between contacts 152. Materials of contacts 152 are such that a voltage is produced across contacts 152 when impure water is present due to electrochemical reactions of materials 152 and water. When no water is present, no voltage is produced.

As in sensing component 140 (FIG. 14), sensing component 150 has three cavities within housing 158. Cavity 151 is kept dry by barrier 154 that traps an air pocket above interface 155, allowing only the tips 159 of contacts 152 to pierce through interface 155 and touch water. The portion of contacts 152 above tips 152 stays dry to reduce contamination and erroneous alarms. Cavity 153 is also dry and contains the upper tips on contacts 152 and wires 156. Cavity 157 is a flooded cavity where the water level matches water level 8 outside housing 158.

With some modifications, circuit 40 (FIG. 5) can output an audible alarm when no water is present between tips 159 of contacts 152. Materials 152 act as a variable voltage source. The first modification is to eliminate resistor 42a of circuit 40 and replace variable resistor 42b with variable voltage source as contacts 152. Second, reverse the polarity of comparator 44 (that is, connection 47b is the negative input and connection 47a is the positive input). Resistors 43 set the voltage of input 47a of comparator 44 such that if input 47b from variable voltage source 152 has a higher voltage than input 47a, the output voltage of comparator 44 approaches ground. Otherwise when the voltage at input 47b is less than that of input 47a, the output voltage of comparator 44 approaches battery 12 supply voltage.

When there is air surrounding contact tips 159, the voltage at input 47a exceeds that of input 47b, raising the output voltage of comparator 44 turning on oscillator 45 and emitting sound from speaker 46, thus signaling that water level 8 is too low. When water level 8 is above contact tips 159, a voltage by electrochemical reaction of contact 152 materials raises the voltage on input 47b. The voltage output of comparator 44 approaches ground turning off oscillator 45 and halting sound from speaker 46. Hence when water is present, no alarm sound occurs.

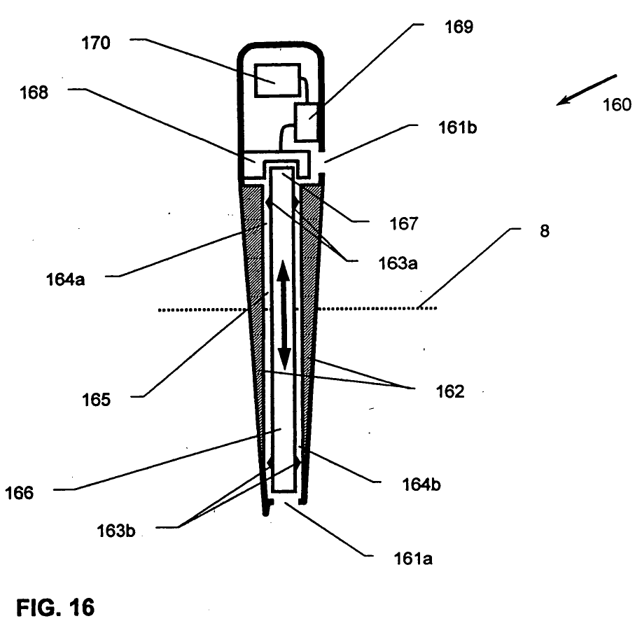

Floats: Another method of sending a low water alarm for cut plants is to use a float to move the water level sensing at the bottom of device 6 closer to the electronics at the top. FIG. 16 shows a schematic of device 160, similar to device 6 of FIG. 3 except for the contents of the housing.

Device 160 has a flooded cavity 165 open to water at bottom opening 161 a and to air at top opening 161b. Non-conducting housing 162 forms cavity 165 into a shape having the same cross-section from top to bottom. Guides 163a maintain the correct gap 164a at the top of float 166; guides 163b maintain the correct gap 164b at the bottom of float 166. Guides 163 are small dome-shaped bumps that encircle the perimeter both at the top and bottom of float 166. Typically three or more guides 163 at both the top and bottom locate float 166 away from cavity 165 walls. Space between guides 163a or 163b at either location let water flow freely between them, allowing water to fill gap 164 between float 166 and walls of cavity 165 as water level 8 rises. The shape of guides 163 is important to minimize surface tension. Water held by surface tension on the domed tip of guide 163 has minimal contact area with the interior walls of cavity 165.

As water level 8 rises, water entering opening 161 a will flood gap 164 between float 166 and cavity 165 walls. Float 166 will begin to float when its buoyancy forces exceed its weight. Float 166 is a hollow structure with impermeable walls. By proper design and weighting of float 166, the buoyancy point can be set to a alert water level. When float 166 rises within cavity 165, its tip 167 rises into the proximity of detector 168.

Detector 168 uses any of several different means to detect tip 167 of float 166. One method is optical: a light or light emitting diode (LED) on one side of detector 168 illuminates a photodiode on the other side of detector 168, signaling circuit 169 when the photodiode is blocked by opaque tip 167. Another method is mechanical: float 166 pushed upward on microswitch detector 168 signals circuit 169 that float 166 has risen. Another method is electromagnetic: a small magnet attached to tip 167 is detected by Hall-effect detector 168. Another method is inductive: a small piece of metal attached to tip 167 is detected by eddy current detector 168. Another method is electrical resistance: metal or other low resistance material attached to tip 167 makes electrical contact with detector 168.

Regardless of the detection method, float 166 separates tip 167 from contaminants on the opposite end of float 166. As in other embodiments, battery 170 powers detector 168 and circuit 169. Circuit 169 signals a low water condition with an audible alert.

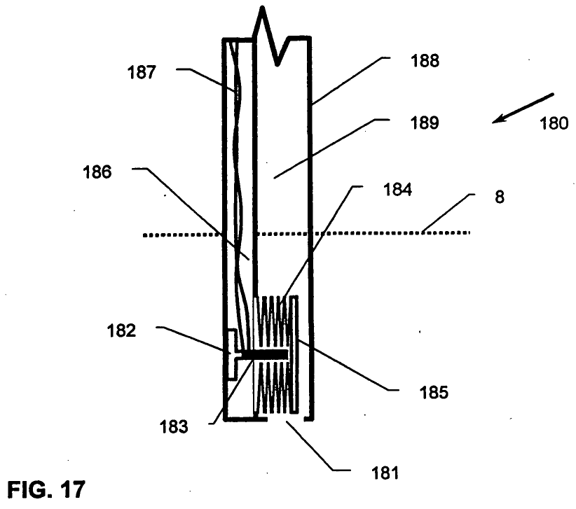

Pressure: A last method of sensing a low-water condition uses a pressure switch. FIG. 17 shows the sensing component 7 of device 6 as sensing component 180. FIG. 17 shows flooded cavity 189 adjacent to dry cavity 186. The flooded cavity 189 lets water in and out via opening 181 and air in and out through a vent similar to vent 161b (FIG. 16).

Separating dry cavity 186 from flooded cavity 189 is bellows 184. The end plate 185 of bellows 184 deflects under the differential pressure between cavities 189 and 186. The bellows 184 must be very flexible to give a reasonable deflection to sense the location of water level 8. A typical device 6 needs a depth resolution of a few millimeters of water, or about 0.003 PSI.

For the most flexibility (most deflection per mm water), the bellows material must be low modulus and deflect without taking a permanent set. The larger its outside diameter, the smaller its inside diameter and the thinner the bellows material, the more flexible is bellows 184. Each convolution of bellows 184 from inside diameter to outside diameter acts like a miniature beam. Long, thin beams have the most flexibility.

Bellows of this type can be made by vacuum-forming plastic over a mandrel. The mandrel itself is cut from a low-melting material such as wax having the same outer shape as bellows 184 inside shape. After vacuum-forming thin thermoplastic material over the bellows, the wax plus bellows is heated to melt out the wax, leaving only the bellows. Alternatively the mandrel can be made of a material such as salt that can be dissolved out after vacuum forming.

In another alternative, the mandrel can be made of steel or other machined material having the shape of a helical surface such as a screw. After vacuum forming, bellows 184 is unscrewed from the helical mandrel. The same technique can be used to injection mold bellows 184. In this case, the mandrel is a core of the injection mold. At the end of each mold cycle, the mandrel is “unscrewed” from the mold (drawing out the core one bellows spacing for each full rotation of the core).

Regardless of the method of making bellows 184, end plate 185 is bonded by adhesives to the closed end of bellows 184. The bellow's open end is bonded to the partition of housing 188 between cavity 186 and 189. Inductive coil 183, wrapped around bracket 182 is connected by wires 187 to a self impedance circuit similar to circuit 50 (FIG. 6). Driven at the LR break frequency of the coil 183 and resistor 54, the coil is most sensitive to phase changes of coil 183, detected by the impedance at contacts 56.

Besides an inductive coil 183, other types of position sensors are suitable to detect the absence of water pressure against bellows 184. For example, a microswitch instead of coil 183 can detect when bellows 184 is fully expanded and a potentiometer can replace coil 183 to detect the motion of end plate 185. Also a force transducer can replace coil 183 such that the tip of the force transducer presses against end plate 185 with a higher force as the water level 8 increases. Circuits such as circuits 40, 50 and 60 determine a low water condition from these alternative sensors.

Further modifications of the invention herein disclosed will occur to persons skilled in the art and all such modifications are deemed to be within the scope of the invention as defined by the appended claims.

What is claimed is:

1. An alerting device for detecting a low-water condition in the container of a cut plant comprising:
a housing having sensing means in its lower portion for sensing the absence of water and alarm means in its upper portion for producing an audible alert when the absence of water is detected;
wherein said sensing means and alarm means form a one-piece rigid structure; and wherein sensing means and alarm means operating by electricity utilizing electrochemical battery means.

2. The alerting device as claimed in claim 1, wherein:
said housing having at least one dry cavity extending from the sensing means to the alarm means.

3. The alerting device as claimed in claim 1, wherein:
said electrochemical battery means contained in a dry cavity in the housing above the expected high water level of the container.

4. The alerting device as claimed in claim 1, wherein:
said housing having at least one flooded cavity extending from the sensing means to a point above the expected high water level
said flooded cavity having at least one opening to outside the housing above the expected high water level;
said flooded cavity having at least one opening to outside the housing below the sensing means

5. The alerting device as claimed in claim 4, wherein:
said flooded cavity having at least one opening to outside the housing below the sensing means removes debris from water entering the cavity by employing a filter means in the opening.

6. The alerting device as claimed in claim 1, wherein:
said housing is non-conducting, allowing sensing means to operate through non-conducting partitions between flooded and dry cavities within the apparatus.

7. The alerting device as claimed in claim 1, wherein:
said sensing means interacts with water through the air water interface of a dry cavity open at the bottom and closed at the top and sides.

8. The alerting device as claimed in claim 1, wherein:
said sensing means detects the absence of water by employing thermal means to distinguish the difference in sensing means impedance between air and water.

9. The alerting device as claimed in claim 1, wherein:
said sensing means detects the absence of water by employing vibration means to distinguish the difference in sensing means impedance between air and water.

10. The alerting device as claimed in claim 9, wherein:
said sensing means detects the absence of water by producing an audible alert through the vibratory interaction of the sensor means itself.

11. The alerting device as claimed in claim 1, wherein:
said sensing means detects the absence of water by employing viscosity measuring means to distinguish the difference in sensing means impedance between air and water.

12. The alerting device as claimed in claim 1, wherein:
said sensing means detects the absence of water by employing density measuring means to distinguish the difference in sensing means impedance between air and water.

13. The alerting device as claimed in claim 1, wherein:
said sensing means detects the absence of water by employing acoustic means to distinguish the difference in sensing means impedance between air and water.

14. The alerting device as claimed in claim 1, wherein:
said sensing means detects the absence of water by employing electromagnetic means to distinguish the difference in sensing means impedance between air and water.

15. The alerting device as claimed in claim 1, wherein:
said sensing means detects the absence of water by employing capacitive means to distinguish the difference in sensing means impedance between air and water.

16. The alerting device as claimed in claim 1, wherein:
said sensing means detects the absence of water by employing microwave means to distinguish the difference in sensing means impedance between air and water.

17. The alerting device as claimed in claim 1, wherein:
said sensing means detects the absence of water by employing electrical contact means to distinguish the difference between air and water.

18. The alerting device as claimed in claim 1, wherein:
said sensing means detects the absence of water by employing electrochemical means to distinguish the difference between air and water.

19. The alerting device as claimed in claim 1, wherein:
said sensing means detects the absence of water by employing a self impedance circuit whereby a single transducer interacts with the medium and changes its impedance to distinguish the difference between air and water.

20. The alerting device as claimed in claim 1, wherein:
said sensing means detects the absence of water by employing a mutual impedance circuit whereby one transducer interacts with the medium and a second transducer interacts with the same medium, changing its impedance to distinguish the difference between air and water.
